(19) United States
(12) Patent Application Publication
(10) Pub. No.: US 2007/0079719 A1
(43) Pub. Date: Apr. 12, 2007

(54) Ink jet printing and drying a printing material

(76) Inventors: Domingo Rohde, Kiel (DE); Knut Behnke, Flintbek (DE); Frank-Michael Morgenweck, Kiel (DE); Jose M. Catala-Civera, Valencia (ES); Michael J. Piatt, Dayton, OH (US)

Correspondence Address: Mark G. Bocchetti;Patent Legal Staff, Eastman Kodak Company, 343 State Street, Rochester, NY, 14650-2201, US

(21) Appl. No.: 11/478,042

(22) Filed: Jun. 29, 2006

(30) Foreign Application Priority Data
Jun. 30, 2005 (EP) 05014123.3
Mar. 8, 2006 (EP) 06004695.0

(51) Int. Cl. B41F 23/04

(52) U.S. Cl. 101/487

(57) ABSTRACT

With a printing material that is to be printed at least two times with color by an ink jet printing device, microwaves are used for drying the ink on the printing material. The printing material is printed, in chronological order, at least two times with color, and the printing material is subjected to microwaves between one printing with color and the next printing with color.

### FIELD OF THE INVENTION

The invention relates in general to a method of completing a printing material that is to be printed at least two times, with color, by means of an ink jet printing device, preferably a continuously processed roll printing material, in which case microwaves are used for drying the ink on the printing material.

Further, the invention relates to an ink jet printing device for printing at least two times, with color, on a printing material, preferably a continuously processed roll printing material, which includes a heating device for subjecting the printing material to microwaves in order to dry the ink applied to the printing material.

### BACKGROUND OF THE INVENTION

A method and a device for ink jet printing and microwave drying of the printed image have basically been known from U.S. Pat. Nos. 6,425,663; 6,444,964; and 6,508,550. Considering these patents, an ink jet print head, which moves line-by-line across the printing material and which has several ink cartridges, is used to print a multi-color printed image on the printing material, and a heating device, which subjects the printing material to microwaves and preferably follows the print head, is used for drying the printed image.

Ink, which is applied by an ink jet in a printing process, exhibits extremely low viscosity and, for example, contains a relatively high percentage of water, for example 95%. As a result, an extremely high percentage of moisture is applied to the printing material during the printing operation; this moisture can be handled by the printing material only with difficulty and only up to a certain limit until the printing material will potentially even tear. Roughly this means that with decreasing quality and cost of the printing material, this absorption limit decreases as well. As a result, especially high-quality and expensive printing materials, which, for example, are provided with surface coatings, are particularly suitable for ink jet printing. However, considering, in particular, a commercially operated roll printing machine, which, for example, prints up to 200 running meters per minute when an ink jet printing process is used, such an expensive printing material frequently represents too high a cost factor for the operator or the customer. Besides, potentially not every customer demand for a specific printing material can be met, because a printing material selected by the customer could probably be printed in an offset printing process but is not suitable for the ink jet printing process for the described reasons. If, nevertheless, a printing material which cannot absorb enough moisture is to be used, the application of moisture must necessarily be reduced in the printing process, which means that, at the same time, a smaller amount of dye must be used because, for example, the ratio of water and the percentage of dye must remain constant at 95%, for example, to allow processing in an ink jet print head. This means that only the total amount of ink for the respective print job can be reduced; this, however, automatically results in a loss of quality of the printed image, because only a lower color density can be produced, i.e., the used color remains paler in the printed image. This is particularly critical in a multi-color print, in which adequate color density is supposed to be achieved for each individual color separation, in which, however, the limit of moisture saturation of the used printing material is reached particularly quickly.

Therefore, the purpose of the invention is to make the ink jet printing process less dependent on the quality of the printing material and to maintain, or even improve, the quality, specifically the color density, independent of the type of the printing material used in the ink jet printing process, and, in addition to, potentially accelerate the completion of a print.

### SUMMARY OF THE INVENTION

In accordance with the present invention, this purpose is achieved, considering the method, in that the printing material is printed, in chronological order, at least two times with color, and in that the printing material is subjected to microwaves between one printing with color and the next printing with color. These at least two colors are not necessarily, but preferably, different colors. Also a single color could be printed in different stages to increase the ink loading step by step. Also, “Black” is a color. Therefore, the invention may be advantageous also for Black-and-White printing. Of course, the inventive ink jet printing can be done drop-on-demand or continuous, with for example both fixed printing heads on a web or translating print heads on a carriage.

Consequently, in accordance with the invention, advantageously especially each color separation, or added color separation, is first individually dried partially, or preferably completely, before the next color separation is added. In so doing, the printing material is subjected to microwaves each time. Final drying is possible only after the last color separation, for example, by using a heatable drying cylinder, which can additionally stretch and smooth the printing material while it is being dried. Also in this case, the application of microwaves or any other suitable drying method may be selected to accomplish this. However, the inventive use of microwaves is particularly suitable between color separations or color printing steps. The inventive microwave drying could, if desired, be combined or used in conjunction with other drying technologies.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 is a side elevation of a schematic overview of the inventive device, in one embodiment;

FIG. 2 is a front elevation of the inventive microwave heating device, in one embodiment;

FIG. 3 is a schematic, perspective view of two microwave applicators, which are offset transversely with respect to each other, of a heating device as in FIG. 2;

FIG. 4 is a schematic sectional view of a second embodiment of a microwave applicator with indicated perspective;

FIG. 5 is a representation of a qualitative function of the moisture saturation of a printing material in the course of successive printing steps with four-ink jet printing units;

FIG. 6 is a schematic plan view on a first example of overlapping printing units with a microwave heating device; and

FIG. 7 is a schematic plan view on a second example of overlapping printing units with two microwave heating devices.

### DETAILED DESCRIPTION OF THE INVENTION

Inasmuch as ink penetrates the printing material, specifically paper, within approximately 100 milliseconds, and affects the structure of the printing material after 0.5 seconds to 2 seconds, the entire printing process involving all colors must be carried out as rapidly as possible. Otherwise, dimensional changes, for example, due to a swelling of the fibers of the paper, lead to considerable deviations when individual colors are printed successively, i.e., for example, deviations regarding the color register or color alignment.

Thus, the dryer used between the printing units must be efficient and require only a small space in advance direction of the printing material. The requirements regarding efficiency and space are met by a microwave heating device for heating areas printed with ink, in particular, preferably with the additional use of a ventilation and venting device used for cooling the printing material and, at the same time, used for removal of accumulated moisture.

A particular advantage of heating printing material, in particular, papers printed with water-based ink, with microwaves, is the option of adjusting the microwave heating device in such a manner that areas printed 100% with ink are heated considerably more than unprinted paper, because, in fact, the water contained in the ink absorbs microwave power particularly well. In so doing, typical temperature differences between areas of the printing material printed with ink and unprinted areas may be 15° C. to 30° C.

Another modification of the invention provides that a magnetron is used as the microwave source, in which case, preferably, the printing material is guided through a resonator zone in which stationary microwaves are generated. In so doing, the tuning parameters for the application of microwaves may be adapted to the physical properties of the printing material and/or the transport speed of the printing material. Main tuning parameters may be the power output of the microwave source, or the diaphragm dimensions and/or the resonator length. In so doing, the resonator length can be changed and tuned with a type of plunger piston, a so-called “plunger”. Another option for tuning the conditions in the resonator or applicator is the variable input of a dielectric load in the hollow chamber of the resonator. As a result of this, in particular also load changes due to a change of printing material, e.g., material having a different weight per unit area, can be compensated for in order to have substantially constant drying conditions with different printing materials.

The power output of the microwave source for the application of microwaves between respectively two color printing steps could be selected to be approximately 6 to 25 kW (Kilowatt), preferably approximately 9 kW. In so doing, an irregular power input between respectively two color printing steps could be provided in order to accommodate special circumstances. For example, a power distribution could be adjusted in such a manner that, in the area adjacent the previous color printing step, a higher power input is provided than in the more remote area that is already adjacent the next color printing step, in order to achieve the fastest possible drying step after the printing process, in order to stop, for example, the continued impairment of the fibers of the printing material, whereupon a more gentle drying step may follow and, overall, only limited power needs to be made available, such power being made available in an effective and targeted manner. To achieve this, for example, areas with a power input of approximately 6 kW and 3 kW, respectively, may be provided. A power distribution may take place in different ways. Respectively, one resonator or applicator may be connected to its own magnetron, which makes the desired power available. However, it is also possible to use one magnetron for several resonators; and the power output of the magnetron can be distributed uniformly or irregularly by so-called power splitters over the different resonators or applicators, which, in the present context, are also frequently referred to as channels.

Depending on selection or circumstances, the terms “applicator” and “resonator” can mostly be used synonymously, when resonant stationary microwaves are generated in the applicator; or the term “applicator” may be used generically for that component which, as a unit, applies microwaves to the printing material and, to do so, has access to one or more resonators. For the sake of completeness, it should be mentioned in this context that, in accordance with the invention, of course also moving microwaves can be used and be applied to the printing material, for example, with a meandering or annular applicator, in which case the applicator would not have a resonator or would not be a resonator.

Basically, every frequency in the microwave range from 100 MHz to 100 GHz may be used. Usually, industrial, scientific and medical (ISM) frequencies cleared for industrial, scientific and medical use, preferably 2.45 GHz, are used. However, the use of other frequencies within the stated wide frequency range may also have advantages. First and foremost, the preferably water-based ink is to be dried without excessively heating the printing material itself, which makes microwaves having a frequency of approximately 2.45 GHz suitable.

Also, a ventilation and venting device may feature an irregular distribution of ventilation and venting between two respectively color printing steps. In particular, for example, in the area adjacent the previous color printing step, at least predominantly one ventilation step may be provided and in the more remote area already adjacent to the next color printing step, at least predominantly one ventilation step may be provided. This would be advantageous in particular if a printing unit would have, closer to its output side of the printing material, an ink jet device that is sensitive to the injection of air, so that then essentially a ventilation and venting circulation system should be installed, in which the air flows out of this area and not into this area, and, in particular, the injected air is not pressurized. Depending on circumstances, reverse or other distributions are also possible.

There is not much room available for a drying device between the ink jet devices of an ink jet printing machine, even if this machine is configured much larger for commercial use than it is for office use. In so doing, it may not be assumed that this space may be enlarged later because it should be possible to easily retrofit existing printing machines with the inventive device, without requiring a fundamental modification of the printing machine. In conjunction with this, it is in fact a particular advantage of the inventive device and the inventive method that microwave drying can be carried out in a highly restricted space, and still in an effective and rapid manner. In conjunction with this, a preferred embodiment of the invention provides, between respectively two color printing steps, a treatment zone having a adequate length of approximately 15 to 30 cm, preferably approximately 20 to 25 cm, specifically for microwave application and ventilation and venting—including cooling—in transport direction of the printing material.

In this case, it is still possible to provide a printing material transport speed of approximately 50 to 200 meters per minute, in order to still have sufficient time for sufficient drying of the ink by microwaves and for removing moisture, even along short distances. It may even be possible and implementable, between respectively two color printing steps, to dry the ink on the printing material advantageously almost completely, which can result in a particularly good printing quality.

Also, when the inventive drying step is used, the printing material may be duplex-printed, either in that it is turned over and passes again through the same devices, or in that the same devices are made available a second time along the transport path of the printing material. In fact, verso-printing with the use of the inventive drying step is possible with better quality, because the ink applied during the verso-printing step does not “bleed through” to the recto side.

Also, with this invention, an ink jet printing device for printing at least two times color on a printing material, preferably a continuously processed roll printing material, which includes, in order to dry the ink applied to the printing material, a heating device subjecting the printing material to microwaves, and which, in view of the independent solution of the problem to be solved, is characterized in that at least two printing devices arranged in sequence in transport direction of the printing material for printing the printing material respectively with color are provided, and in that a microwave heating device is provided between successive printing devices.

As already mentioned, preferably at least one magnetron is provided as the microwave source, and the inventive microwave heating device preferably includes at least one resonator, through which extends a printing material transport path and in which stationary microwaves are generated. Generally, N resonators may be arranged one after the other. In the resonators, stationary microwaves having a so-called hollow conductor wavelength λ are generated; their intensity depends also on the geometric data of the used hollow conductor. Therefore, the hollow conductor wavelength is not simply the wavelength λ satisfying the known formula c=λ • v, where c represents the velocity of electromagnetic waves and v represents the frequency of the used waves, that can be used to compute the wavelength λ. The respective wave-progression results in regions of different field strengths in the plane of the printing material, whereby the stationary wave extends essentially parallel to the plane. Of course, the progression of field strength is continuous. The maxima regions of successive resonators are preferably offset in a direction transverse to the transport direction of the printing material, i.e., preferably with the use of two resonators that are offset by λ/4 with respect to each other, this—as generally regards N resonators—corresponding to an offset of respectively λ/2N, whereby N=2 in the case of two resonators. The offset arrangement of the stationary microwaves or the field strength progressions in the resonators, advantageously leads to a particularly uniform, homogeneous heating of the area subjected to microwaves. It may be given consideration to use four resonators instead of two resonators or two times two resonators, namely N=4, or N=2 twice in succession, i.e., two independent heating devices, one after the other, as it were. Also in this case the appropriate number of magnetrons may be provided as microwave sources, or the power may be split by power-splitters.

In a preferred embodiment of the inventive device, the width of the resonator along the transport path of the printing material is kept as small as possible in order to simplify handling of the printing material and is selected large enough to keep the electrical field in the resonator below the air-breakdown voltage. In so doing, the width of the resonator should be selected as a function of the velocity of the printing material and/or the input microwave power of the resonator. Preferably, the resonator has a width of approximately 1 cm to approximately 10 cm. This means that the use of at least one resonator having a width of approximately 1 cm to approximately 10 cm in advance direction of the printing material is preferred in order to simplify handling of the printing material and still enable sufficient power (for example, 1-10 kW per resonator), without the occurrence of voltage breakdown.

As a microwave applicator also a so-called ridged applicator could be used, which is structured to focus the microwave energy in the printing area, preferably just in the area, where the ink contacts the printing material, i.e., beneath a printing head. In such an applicator a traveling microwave would be preferred. As a structure element for the ridged applicator an element could be used which is already in place, for example a metallic guiding roller for the printing material.

As already described, a ventilation and venting device is provided for the area that is subjected to microwaves, in which case, under certain circumstances, an irregular distribution of ventilation and venting steps can be advantageous and be provided between respectively two printing devices. For example, in the area of the previous printing device at least predominantly one venting step may be provided, and in the more remote area that is already close to the next printing device, at least one ventilation step may be provided.

A further modification of the invention provides that, in order to shield the microwaves of the heating device, a so-called choke structure is provided. Leakage radiation exiting from the resonators through passage openings for the printing material can be reduced by setting up such a choke structure and/or by using absorbent materials outside the resonator. To do so, the invention provides that the choke structure has essentially rod-shaped choke elements arranged at regular distances from each other, in which case such rod-shaped choke elements preferably are arranged in double rows and, in so doing, are preferably arranged in line with each other or exactly offset with respect to each other. The cross-section of the rod shape may be round or angular.

The zones of a choke structure can also be used as zones for ventilation and venting and for cooling the printing material, in that air-input and air-output openings are provided in these zones, which are connected to an air-guiding system. Basically, even in the resonator zones, air holes, which, for example, have a diameter of less than or equal to 3 mm, are not critical. A ventilation or venting in the resonator zone itself, in particular, in the choke structure, can be provided to supplement a downstream ventilation and venting device; advantageously, this also provides preferably an integrated solution by creating a compact structural unit in which heating, ventilation and cooling are combined in an integral manner. In order to form air jets, the addressed “holes” can be configured as nozzles or be equipped with nozzles.

For broader printing material at least two printing units are required for a seamless printing area traverse to the direction of transport of the printing material, whereby these printing units follows each other in the transport direction because they have to overlap each other to avoid a seam between them. But this would mean with the inventive microwave heating, that the distance in the transport direction from one of these printing units to the microwave-heating unit is greater than from the other. Therefore, also the time between printing and drying becomes longer for the longer distant printing unit.

To avoid this disadvantage, a further modification of the invention is characterized in that for each printing of color at least two printing units are provided, one following the other in the direction of the transport of the printing material and overlapping each other for a seamless printing area traverse to the direction of transport, and in that the printing units, having each closer to one of their sides an ink jet device, are oriented in such way, that these ink jet devices are facing each other for minimizing the gap between them in the direction of transport. Doing so, the distance between the ink jet devices and the next following microwave heating device becomes nearly the same.

An alternative modification could be that for each printing of color at least two printing units are provided, one following the other in the direction of the transport of the printing material and overlapping each other for a seamless printing area traverse to the direction of transport, and in that the printing units, having at least one microwave heating device between them. An additional microwave device is provided between the printing devices with this modification, but as both the printing units have only the task to print one color commonly, each of the two printing units per color is followed preferably by a microwave heating unit with only at least half the whole power which is intended for drying for each of the colors. It may be seen, that one microwave-heating unit could be divided in two units with half the power for the also two printing units.

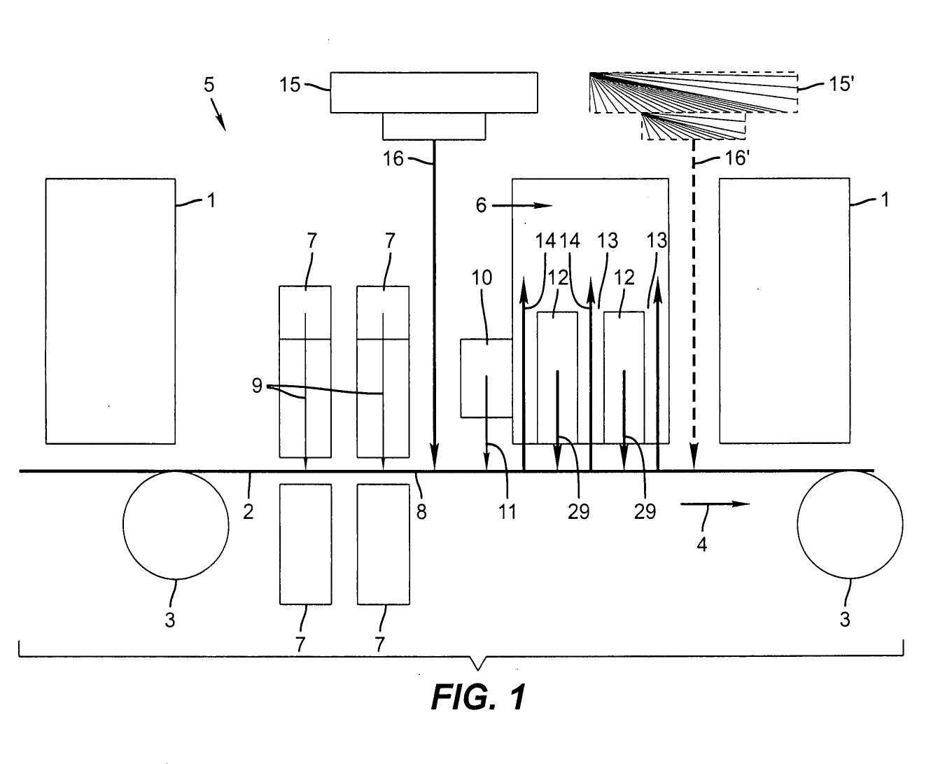

Referring now to the accompanying drawings, FIG. 1 shows a schematic overview of an inventive device, in a side elevation. FIG. 1 indicates two ink jet printing units 1 of an ink jet printing machine for multi-color printing of a printing material 2. Printing material 2 is transported over rollers 3 in the direction of an arrow 4 under printing units 1. In multi-color printing, the printing machine may preferably include four printing units 1, however, more or fewer printing units 1 may be provided. In the illustrated embodiment, a space of approximately 30 cm is provided respectively, between two printing units 1, such space being used in accordance with the invention.

Arranged between respectively two printing units 1, are a microwave heating device 5, which, for example, could take up approximately 5 cm to 10 cm, and a ventilation and venting device 6, which, at the same time, acts as a cooling device and which, for example, could take up 15 cm to 20 cm.

The microwave heating device 5 includes two microwave applicators 7, in which stationary microwaves are generated and through which printing material 2 is transported by way of respective gaps 8. In so doing, the microwave energy applied to printing material 2 is used to dry the ink on printing material 2, such ink having been applied to printing material 2 by the previous printing unit 1, before the printing image passes through the next printing unit 1 to be printed with the next ink or color.

Arrows 9 indicate that a gentle air current is also directed through applicators 7 in order to transport moisture out of applicators 7. For the same purpose, an upwardly directed air-flushing step to transport dust toward the outside may be provided in the lower part of the applicators below printing material 2.

Ventilation and venting device 6 first includes an air-cooling device 10, which, viewed in transport direction 4, is first to follow microwave heating device 5. This air-cooling device 10 applies blown air 11 to printing material 2.

Air blown by ventilation and venting device 6 onto printing material 2 generally will apply a pressure of approximately 10 mbar to approximately 200 mbar, which is mentioned here only to convey an idea of the magnitude. In particular, laminary air currents applied to the printing material are to be interrupted in order to permit a removal of moisture.

The distance of air-cooling device 10 from printing material 2 can be varied independent of the remaining part of ventilation and venting device 6. Also, the mentioned remaining part of ventilation and venting device 6 can be varied as to its distance from printing material 2, i.e., preferably up to a minimum distance of approximately 1 mm.

Ventilation and venting device 6 has two (additional) air blowers 12, the position of which can be changed parallel to printing material 2, i.e., in the direction of arrow 4 and in the opposite direction, and which blow air in the direction of arrows 29 against printing material 2. Furthermore, ventilation and venting device 6 includes zones 13 in which air 14 is evacuated in order to remove and discharge moisture from the drying process. Evacuation zones 13 are, in particular, next to the blow zones 12, shielding such zones against the outside in order to avoid the influence of blown air on the printing process of adjacent printing units 1.

On the side of ventilation and venting device 6 facing the next printing unit 1, another air-cooling device—potentially the type of air-cooling device 10—may be provided, such cooling device again massively cooling printing material 2 to reduce the material's temperature before it enters the next printing unit 1, in that an air curtain, a so-called air knife acts on printing material 2. In this instance, pressurized air can be used in the conventional manner.

In order to gain more space for the blow zones above printing material 2, it would be conceivable to evacuate air laterally toward edges 2, i.e., to move the evacuation zones accordingly. In addition it would be conceivable to heat the supplied air or blow air in order to allow it to absorb more moisture, in which case, for example, the discharge heat of heating device 5 could be used.

In addition, a pyrometer 15 may be provided in order to measure the temperature of printing material 2 or its printed image in the direction of an arrow 16 in various positions. As a result, valuable data can be yielded in particular between microwave heating device 5 and ventilation and venting device 6 and between ventilation and venting device 6 and the next printing unit 1. To achieve this, the location of the pyrometer, as indicated in positions 15′, 16′ in dashed lines, can be changed. Pyrometer 15 is provided, in particular, for testing and adjustment purposes and is not necessarily part of the inventive device.

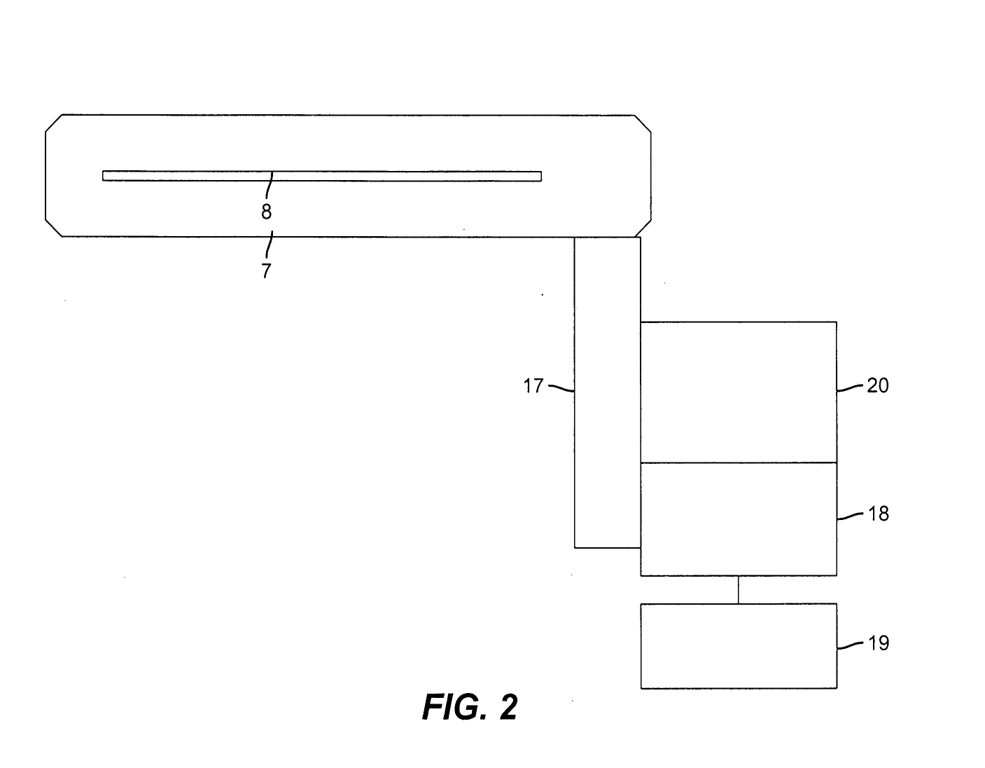

FIG. 2 shows an applicator 7, which has a gap or slot 8 to allow printing material to pass through. This applicator 7 is connected to a hollow microwave conductor 17, which connects applicator 7 with a magnetron 18, which acts as the microwave source, in which case usually additional components may be present, which will not be described in detail here, such as, for example, a launcher for launching microwaves into the hollow conductor, a circulator and a microwave antenna. Magnetron 18 is electrically connected to a power supply 19. In addition, a water load 20 with a water circulation step is provided and indicated in FIG. 2.

Microwave conductor 17 conducts microwaves from the magnetron into applicator 7, which, in turn, emits microwaves on the printing material. Stationary microwaves are generated in the applicator. Reflected microwaves are guided into water load 20 and are re-directed into thermal energy. To achieve this, the water load features a water circulation of approximately 6 liters per minute. For example, magnetron 18 could have a power of 6 kW for two applicators (2 times 3 kW), and the power supply could have an output of 8.5 kW at 1 amp. Even higher power outputs may be provided.

In addition, sensors, for example for leakage radiation detection or for temperature measurement, or for the detection of arcs in case of voltage breakdown of the applicator may be provided.

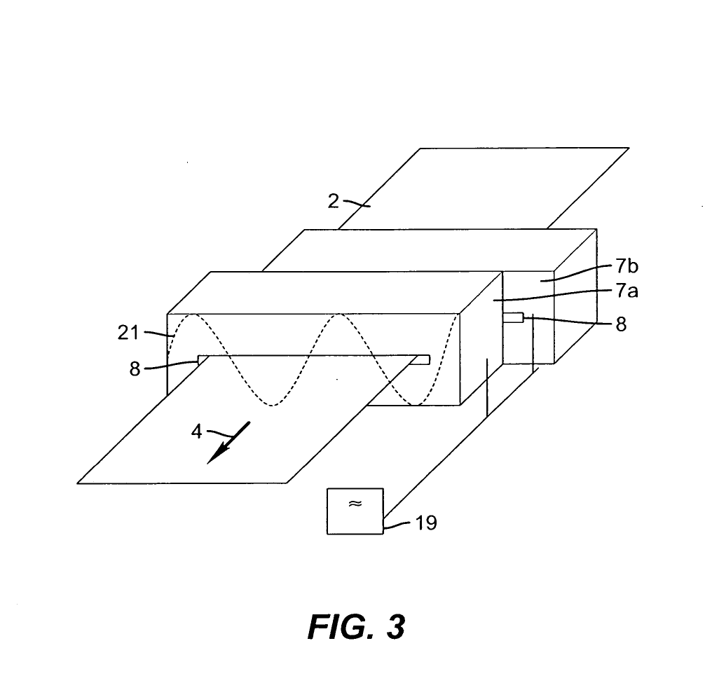

FIG. 3 shows a schematic perspective view of two microwave resonators 7a and 7b—offset transversely with respect to each other—of a heating device as in FIG. 2. This representation is intended only for illustration and not for representation of actual mechanical relationships. The resonator lengths are only indicated and, in an engineering sense, are not completely depicted applicators. As in previous figures, the same components have the same reference numbers in FIG. 3. To provide a clear arrangement, microwave conductor 17 and magnetron 18 have been omitted. Only a power supply 19 is indicated.

Basically, indicated in applicator 7a is a stationary microwave 21, which is oriented transversely with respect to transport direction 4 of printing material 2 and parallel to the plane of printing material 2. The second applicator 7b is offset transversely with respect to first applicator 7a, in which case this offset is depicted in an exaggerated manner for clarity's sake. In fact, applicators 7a, 7b are to be offset with respect to each other only by a fourth of the wavelength of the microwave 21. This transverse offset ensures uniform spatial or surface heating of printing material 2 or the ink on such printing material.

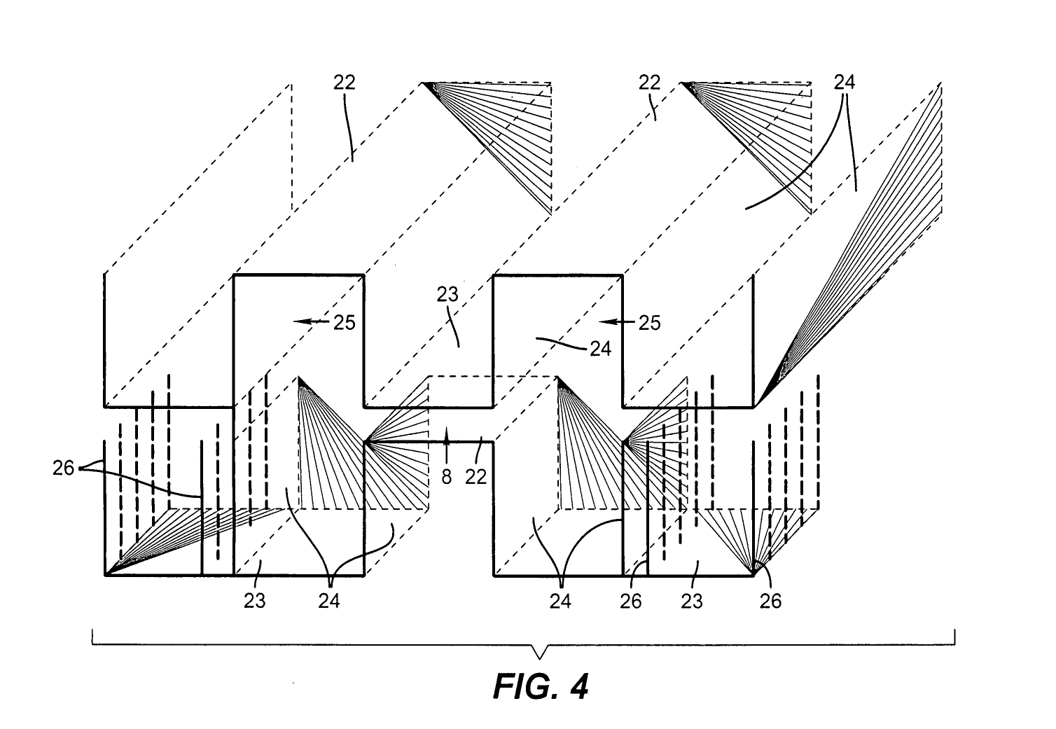

FIG. 4 shows a schematic sectional view of a geometric detail of a second, preferred example of embodiment of a microwave applicator, with the perspective being indicated. The section of applicator 7 indicated in FIG. 4 has a zigzag-shaped structure or rib structure. The zigzag form of the upper and the lower parts of applicator 7, between which extends gap 8 for passing through printing material 2, essentially has cover parts 22 or bottom parts 23, and lateral walls 24. These are used to construct two central hollow chambers 25, in which stationary microwaves 21 are formed. Consequently, the two hollow chambers 25 are two resonators, in which, in accordance with FIG. 3, also stationary microwaves that are offset transversely with respect to each other can be produced. For each of these hollow chambers 25, a separate magnetron could be provided, or one magnetron could supply both hollow chambers 25 as two channels over which, the power is distributed with the use of a power splitter. However, this component could be described as an applicator with two resonators. Depending on selection and circumstances, the terms “applicator” and “resonator” can mostly be used synonymously, for example in view of FIG. 3, when resonant stationary microwaves are generated in the applicator; or, as suggested by the embodiment of FIG. 4, the “applicator” can be generically identified as the component which, as a unit, applies microwaves to the printing material and, to achieve this, has access to one resonator or several resonators. For the sake of completeness, it should be mentioned in this context that, in accordance with the invention, of course also moving microwaves can be used and applied to the printing material with a meandering or annular applicator, in which case the applicator would not include a resonator or would not be a resonator.

In addition, as mentioned farther above, a heating device, which uses, for example, two times two resonators, could be provided. The applicators of FIG. 4 would be particularly well suited for this, because applicators of this type, for example two applicators, could be arranged next to each other as in a modular system, for example, connected together by flanges. Therefore, considering the illustration of FIG. 4, the same module could be attached again to the left or right of the shown module. Such a double-assembly could be provided with a single appropriately powerful magnetron and one power splitter.

Next to the two hollow chambers 25, edge zones are provided, in which, in particular, choke structures are arranged. Such structures have two rows of rod-shaped upward pointing choke elements 26 used to prevent, or at least attenuate, leakage radiation. In this case, choke elements 26 of the two rows are in line with each other and not offset with respect to each other. In particular, surfaces 22, 23 of the applicators, which form the boundaries of gap 8, are provided with holes in order to allow the air flow indicated by arrows 9 in FIG. 1, such air current effecting only a way of flushing the resonator, i.e., the hollow chambers, with air. As already described further above, however, in fact the choke region, as well as the regions between and next to the hollow chambers can be used as ventilation and venting zones and cooling zones; this has the advantage of a very close and rapid cooling step, which is spatially and chronologically very close to the heating step. For example, the zone between hollow chambers 25 could be used for a strong injection of air in the way of air current 29 as in FIG. 1, and the choke region could be used for a strong evacuation of humid air in the way of air current 14 as in FIG. 1. If two applicators as in FIG. 4 are connected with each other by flanges, the air injection zones and the air evacuation zones could be interchanged in the zones, in a way that, in the case of the second applicator, the previously mentioned zones are used in reverse order, i.e., in that they are inverted, as it were. In this case, the sequence is selected in such a manner that, when viewed in transport direction 4 of the printing material, first an evacuation zone is set up and last a blowing zone is provided.

For clarity, FIG. 4 shows only the foreground contours of the modules in solid lines, while the indicated perspective lines extending into the image plane are shown only in dashed lines.

As already addressed farther above, in particular, the width of the resonator may be selected in such a manner that the risk of breakdown voltage is avoided. In addition, it is conceivable to detect potentially occurring arcs in order to switch off the device and to wait. Voltage breakdown can be caused for example even by dirt deposits. A cleaning mechanism for the applicator could be provided in the inventive device. Also, a device for a general safety shutoff may be provided in an inventive device. For example, printing material could jam in the heating device zone and thus result in overheating, potentially even in a fire hazard. In order to exclude this, suitable sensors, which perform an emergency shutdown, could be installed. In so doing, the microwave device used in accordance with the invention has the advantage that, without any time delay, instantly after a shutdown, the heating process is stopped, while in other types of heating devices the heating temperature drops only gradually, i.e., a coasting of the temperature continues for some time.

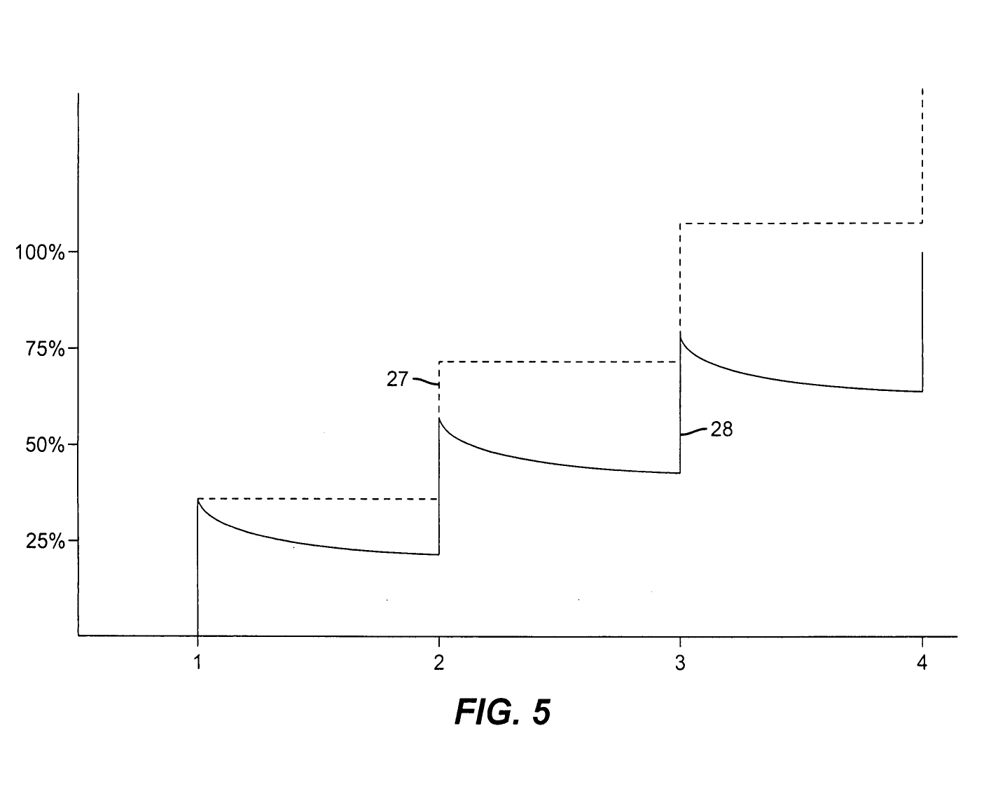

FIG. 5 shows a qualitative, functional representation of the moisture saturation of a printing material with successive printing steps with four-ink jet printing units. FIG. 5 does not show a quantitative but only a basic representation. In FIG. 5, entered on the abscissa, are numbers 1 through 4 of the four printing units assumed in this example. The moisture saturation of the printing material in percent is entered on the ordinate. The representation is to illustrate that, when printing the printing material successively with the use of printing units, a moisture saturation of 100% of the printing material would occur at potentially the third printing unit; this is indicated by a dashed curve 27. As of the fourth printing unit, the moisture saturation, in this case, would reach a value of 130%; only good, expensive printing materials would not be damaged by this, such materials being coated papers, in particular.

If, in accordance with the invention, after each printing of the printing material with a printing unit, the ink on the printing material is initially at least briefly partially dried with the use of microwaves, the moisture saturation value will initially drop again and more absorption capacity remains for subsequent printing steps. A moisture saturation of 100% is now reached only after printing with the fourth printing unit. As illustrated by a solid-line curve 28, now the value of moisture saturation increases only step by step. In this case, advantageously, also less complex, cheaper printing materials can be used.

As already explained above, heating of the ink-carrying printing material with microwaves has the advantage that especially a water-based ink is heated by microwaves while the printing material, i.e., in particular the paper itself, is not heated as much. Of course, the paper is initially warmed up at least indirectly, this being a function of the ink/paper ratio, i.e., the amount of printing and the paper's weight per unit area.

For example, tests have shown that a printed area on a paper, i.e., a printed image of ink, is heated with a microwave heating device 5 to a temperature of approximately 60° C., while the surrounding area of the not printed paper reaches only a temperature of approximately 35° C. when subjected directly to microwaves.

For example, a paper printed with ink was dried with a microwave output of 6 kW, distributed over two resonators with respectively 3 kW, in which case the paper coming off the roll was transported at a velocity of 2.5 meters per second. If 100% of the area of the paper was covered with ink, a paper having a weight of 75 grams per square meter was heated by such a microwave heating device 5 to an overall temperature of 58° C. directly downstream of the heating device and measured with pyrometer 15 of FIG. 1, while a paper having a weight of 120 grams per square meter was heated to a temperature of only 54° C. After being cooled with ventilation and venting device 6 of FIG. 1, the respective paper, again measured with pyrometer 15, had a temperature of 38° C. and 35° C. respectively, at which temperature it entered the next printing and drying steps.

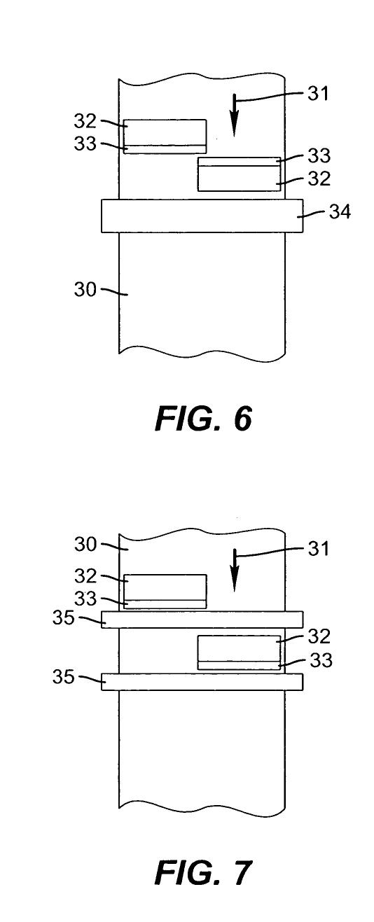

FIG. 6 shows in a plan view a part of an embodiment of an inventive ink jet printing device. Above an endless printing material 30, which is transported in the direction of an arrow 31, are shown printing units 32, following each other in the direction of the arrow 31 and overlapping each other in a transverse direction. The printing units 32 have ink jet device areas 33 near one side of the units. The printing units 32 are oriented so that these ink jet areas 33 are facing each other with only a small gap between them. The printing units 32 are followed by a microwave heating unit 34 in the direction of the arrow 31 and the distance of this microwave heating unit 34 is nearly the same for both of each of the ink jet areas 33.

FIG. 7 shows in a plan view a part of another embodiment of an inventive ink jet printing device. Above an endless printing material 30, which is transported in the direction of an arrow 31, are shown again printing units 32, following each other in the direction of the arrow 31 and overlapping each other in a transverse direction. The printing units 32 have ink jet device areas 33 near one side of the units, facing now both in the direction of the arrow 31. Each of the printing units 32 is directly followed by “the half” of a microwave-heating device 35, that is, a microwave-heating device with only half the power and half the width of the microwave-heating device 34 in FIG. 6.

It should be pointed out again that, as a result of the inventive intermediate drying step, not only more ink can be applied to a less expensive printing material and thus, among other things, the color density and the optical density are improved, but, that each individual ink drop is also prevented more quickly from spreading in the fibers of the printing material, which significantly improves the printed image, in particular its contour sharpness.

Also some other possible failures of ink jet printing, which all can be circumvented by using the invention, should be mentioned here, for example:

“Cockle”-a localized relatively high frequency waviness in a paper caused by excessive ink in a given region;

“Curl”-a single wave of bending over the full size of a paper, typically characterized by paper edge displacement from flatness;

“Bleed”-feathering of dots between one or more colors and the surrounding printing material that increases the dot size and decreases edge acuity;

“Show through”-ink migration through the printing material to the unprinted side; and

“Mottle”-ink coalescence on the printing material forming light and dark areas within solid coverage.

Last, but not least, environmental savings are possible due to the invention, as the used printing material, especially paper, can be thinner.

The invention has been described in detail with particular reference to certain preferred embodiments thereof, but it will be understood that variations and modifications can be effected within the spirit and scope of the invention.

What is claimed is:

1. Method of completing a printing material that is to be printed at least two times with color by an ink jet printing device, preferably a continuously processed roll printing material, wherein microwaves are used for drying the ink on the printing material, comprising:
printing material is printed, in chronological order, at least two times with color, and the printing material is subjected to microwaves between a printing with color and each next printing with color.

2. Method as in claim 1, wherein at least the area subjected to the microwaves is ventilated and vented.

3. Method as in claim 2, wherein the printing material is passed through a resonator zone in which stationary microwaves are generated.

4. Method as in claim 3, wherein the tuning parameters for microwave application are adapted to the physical properties of the printing material and/or to the transport speed of the printing material.

5. Method as in claim 4, wherein the power output of the microwave source, the diaphragm dimensions, the input or variation of a dielectric load and/or the resonator length are provided as the tuning parameters.

6. Method as in claim 5, wherein the power output selected for the microwave source for microwave application between respectively two color printing steps is between approximately 6 and 25 kW, preferably approximately 9 kW.

7. Method as in claim 5, wherein an irregular power input is provided between respectively two color printing steps.

8. Method as in claim 7, wherein, in the area adjacent the previous color printing step, a higher power input is provided than in the more remote area that is already adjacent the next color printing step.

9. Method as in claim 1, wherein microwaves having a frequency of approximately 2.45 Gigahertz are used.

10. Method as in claim 2, wherein an irregular ventilation and venting distribution is provided between respectively two color printing steps.

11. Method as in claim 10, wherein, in the area adjacent to the previous color printing step, at least predominantly one venting step is provided and that in the more remote area already adjacent to the next color printing step, at least predominantly one ventilation step is provided.

12. Method as in claim 1, wherein the ink on the printing material is mostly dried completely between respectively two printing steps.

13. Ink jet printing device for printing at least two times color on a printing material, preferably a continuously processed roll printing material, which includes a heating device for subjecting the printing material to microwaves in order to dry the ink applied to said printing material, comprising:
viewed in transport direction of the printing material, at least two successively arranged printing devices for printing the printing material respectively with color, and a microwave heating device between successive printing devices.

14. Device as in claim 13, wherein at least one magnetron is provided as the microwave source.

15. Device as in claim 14, wherein said microwave heating device has at least one resonator through which passes a printing material transport path and in which stationary microwaves are generated.

16. Device as in claim 15, wherein more than one resonator is used and that the resonator maxima are offset with respect to each other by the hollow conductor microwave length A divided by two times the number of resonators.

17. Device as in claim 13, wherein a ventilation and venting device is provided for the area subjected to microwaves.

18. Device as in claim 17, wherein an irregular ventilation and venting distribution is provided between respectively two printing devices.

19. Device as in claim 13, wherein a choke structure is provided for shielding the microwaves of the heating device.

20. Device as in claim 19, wherein said choke structure comprises essentially rod-shaped choke elements arranged at regular distances from each other.

21. Device as in claim 13, wherein for each printing of color at least two printing units are provided, one following the other in the direction of the transport of the printing material and overlapping each other for a seamless printing area traverse to the said direction of transport, and in that the printing units, having each closer to one of their sides an ink jet device, are oriented in such way, that these ink jet devices are facing each other for minimizing the gap between them in the said direction of transport.

22. Device as in claim 13, wherein for each printing of color at least two printing units are provided, one following the other in the direction of the transport of the printing material and overlapping each other for a seamless printing area traverse to the said direction of transport, and in that the printing units, having at least one microwave heating device between them.

23. Device as in claim 22, wherein each of said two printing units per color is followed by a microwave heating unit with at least half the whole power which is intended for drying for each of the colors.
